(19) United States
(12) Patent Application Publication
(10) Pub. No.: US 2025/0158659 A1
(43) Pub. Date: May 15, 2025

(54) HOUSEHOLD APPLIANCE AND OPERATING METHOD THEREOF

(71) Applicant: ELECTROLUX APPLIANCES AKTIEBOLAG, Stockholm (SE)

(72) Inventor: Luigi BURIOLA, Porcia (IT)

(73) Assignee: ELECTROLUX APPLIANCES AKTIEBOLAG, Stockholm (SE)

(21) Appl. No.: 18/838,754

(22) PCT Filed: Feb. 21, 2022
(86) PCT No.: PCT/EP2022/054197

§ 371 Date: Aug. 15, 2024

(51) Int. Cl. H04B 5/79; F24C 15/00; F25D 29/00; H02J 50/00; H02J 50/23; H02J 50/27

(52) U.S. Cl. CPC H04B 5/79; F24C 15/00; F25D 29/00; H02J 50/005; H02J 50/23; H02J 50/27; F25D 2300/00; F25D 2400/40

(57) ABSTRACT

A household appliance includes a casing, including an interior cavity, and a door, at least one electrical device which is arranged in/on the door, a control unit which is arranged in/on the casing and is configured to control the electrical device, a first wireless power transfer and data transceiver arrangement, which is arranged in/on said casing and configured to be electrically connected to the control unit via first USB electrical connection circuitry, and a second wireless power transfer and data transceiver arrangement, which is arranged in/on the door and configured to be electrically connected to the at least one electrical device via second USB electrical connection circuitry. The first and second wireless power transfer and data transceiver arrangements are arranged to wirelessly exchange data and wirelessly transfer electric power for the electrical device.

The present disclosure relates to a household appliance and an operating method thereof. In particular, but not exclusively, the present disclosure relates to a household appliance provided with a casing, a door mounted on the casing, and an electric device, which is arranged in the door and is configured to communicate with a control unit mounted in the casing, in order to exchange data.

### BACKGROUND ART

As is known, some kind of household appliances such as, for example, cooking devices and refrigerators, are provided with a box casing having inside a cavity, a door coupled to the box casing by hinges in order to be moved between an open position and a closed position of the inner cavity, and a digital camera, which is arranged in the door in order to acquire pictures of the foodstuff contained in the cavity.

The digital camera is connected with a main controller arranged in the box casing, by data lines and power lines. The data lines and power lines are wired from the box casing to the door supporting the digital camera, through the hinges.

The household appliances having the wired architecture of data and power lines to connect the controller to the camera have several technical problems.

Firstly, the presence of the wired data and power lines increases the complexity of assembling and disassembling the door from the box casing and therefore affects the assembly costs and logistic. For example, in standard ovens, i.e. ovens which do not have a door camera, the door can be disassembled, and the hinges can be loosened. This facilitates easier installation, transport, and allows replacement of door parts more easily, and in relation to customer benefit, allows access to the door or parts particularly the glass stack for cleaning purposes. With the provision of the data and power wires, these possibilities are not present any longer, as the data and power wires connection does not allow for such disassembly.

This problem is also present in refrigerators since the data and power wires makes complex the operations required to change the assembly of the door, when, for example it is mounted with a left opening door but there is the need to have a right opening door.

Different configurations of the data and power connection system between an electronic device and controller in household appliances have been devised in order to eliminate wiring.

EP 3 101 769 B1 discloses a household appliance wherein a first circuit unit wirelessly transmits data received from the main controller to a second circuit unit using a first coil, and the second circuit unit wirelessly transmit data input using a second coil.

WO 2020/224966 A1 discloses a domestic appliance having an energy transmission device, wherein for data transmission, a coil is used as a transmitter which can be excited with a data-carrying excitation signal, so that an electrical signal is induced at the opposite coil, which then serves as a receiving coil, from which the data can be correspondingly read out.

DE 10 2013 105 114 discloses an oven comprising a housing and a power supplying system comprising an electric coil which is provided with a second electrical coil contactless interface, associated with a consumer.

US 2017/0288472 A1 discloses an apparatus that includes a power transmitter, data receiver, and an antenna operatively coupled to the power transmitter and data receiver; the antenna being configured to switchably transmit energy from the power transmitter to power a sensor, and receive data to the data receiver from the sensor in which a frequency being used by the antenna is the same for both transmission of the energy and reception of the data.

The systems described above have a series of technical drawbacks.

A first technical problem is represented by the limited data transmission capacity from the electronic device to the controller. The bit rate of the wireless systems of the solutions described above is limited and often unsuitable for managing images provided by modern cameras.

A second technical problem is represented by the need to use an additional battery or a power supply system for the camera in the door with relative costs and complexity.

Moreover, systems described above involves substantial hardware and software changes to make the communication protocols generally available in the communication plugs of the controller and of the digital camera compatible with the circuits and software of the wireless system, causing an increase of costs and complexity.

This disclosure provides a household appliance comprising a wireless data and power system, that is designed to overcome one or more of the technical problems described above.

### DISCLOSURE

According to the present disclosure there is provided a household appliance comprising: a casing, including an interior cavity, and a door, at least an electrical device which is arranged in/on the door, a control unit which is arranged in/on the casing and is configured to control the electrical device, a first wireless power transfer and data transceiver arrangement, which is arranged in/on the casing and configured to be electrically connected to the control unit via first electrical connection circuitry, and a second wireless power transfer and data transceiver arrangement, which is arranged in/on the door and configured to be electrically connected to the electrical device via second electrical connection circuitry, wherein the first and second wireless power transfer and data transceiver arrangements are arranged to wirelessly exchange data and wirelessly transfer electric power for the electrical device.

The first wireless power transfer and data transceiver arrangement may be a wireless power transmitter and data transceiver arrangement. The second wireless power transfer and data transceiver arrangement may be a wireless power receiver and data transceiver arrangement. The door may be mounted on the casing in order to be moved between an open position and a closed position to close said internal cavity.

The first and second electrical connection circuitry may comprise USB electrical connection circuitry. The appliance may comprise the first USB electrical connection circuitry, arranged in the casing and electrically connecting the first wireless power transfer and data transceiver arrangement to the control unit, and the second USB electrical connection circuitry, arranged in the door and electrically connecting the second wireless power transfer and data transceiver arrangement to the electrical device. The first and second USB electric connection circuitry may be able to operate at bit rates equal to or above about 480 Mb/s.

The first and second wireless power transfer and data transceiver arrangements may respectively comprise a first and second short-range transceiver module, the first and second short-range transceiver modules being configured to operate so as to wirelessly exchange data using a bit rate equal to or higher than 480 Mb/s. The first and second short-range transceiver modules may be configured to exchange data over a V band radio frequency (RF) link.

The first wireless power transfer and data transceiver arrangement may comprise: a first short-range transceiver module, which is electrically connected to the control unit by the first USB electric connection circuit in order to exchange data based on a USB protocol, and is configured to operate so as to transmit/receive data at bit rates equal to or higher than about 480 Mb/s, and a first coil which is configured to wirelessly transfer electric power.

The second wireless power transfer and data transceiver arrangement may comprise: a second short-range transceiver module, which is electrically connected to the electrical device by the second USB electric connection circuit in order to exchange data based on a USB protocol, and is configured to operate so as to transmit/receive data at bit rates equal to or higher than about 480 Mb/s to/from the first short-range transceiver module, and a second coil which is configured to wirelessly receive the electric power from the first coil and supply the received electric power to the second short-range transceiver module and to the electrical device by the second USB electric connection circuit.

The first and second short-range transceiver modules may be configured to exchange data using technology utilizing a portion of the radio spectrum with a bandwidth that allows the high bit rates of 480 Mb/s or higher.

Accordingly, it is not only the USB electrical connection circuits that can operate at bit rates above 480 Mb/s but the entire virtual bus created by the USB electrical connection circuits and the wireless power transfer and data transceiver arrangements. The first and second USB connection circuits may be configured to operate to transfer data based on a USB protocol comprising USB 2.0 or later USB protocols. For example, the USB protocol could be USB 2.0 or USB 3.0. The first and second short-range transceiver modules may be configured to perform a tunneling in the USB communication path between the control unit and the electrical device. They may be configured to allow USB 2.0 full speed tunneling, or if the first and second USB connection circuits operate according to a later USB protocol, full speed tunneling matching maximum data transfer rates of those later USB protocols.

The first and second short-range transceiver modules may be configured to perform a virtual USB communication channel to exchange data between the first and second USB electric connection circuits. They may be configured to provide the virtual USB communication channel to exchange data between the first and second USB electric connection circuits at bit rates equal to or higher than about 480 Mb/s. As such, they would have the ability to keep up with the bit rates in the USB electric connection circuits, operating according to USB 2.0 or later protocols, and not act as a bottleneck.

The first and second short-range transceiver modules may comprise radio frequency (RF) millimeter-wave transceivers.

The first and second short-range transceiver modules may comprise V-Band transceivers.

The first and second short-range transceiver modules may be arranged in the casing and the door respectively, at a distance less than 3 cm to each other.

The first and second coils may be coaxial to each other.

The electrical device may comprise at least a digital camera and/or a display lighting device and/or a sensor and/or a USB interface hub device.

The household appliance may be a cooking oven.

The household appliance may be a refrigerator appliance.

The wireless power transfer and data transceiver arrangements may be arranged/integrated in at least a hinge connecting the door to the casing.

The wireless power transfer and data transceiver arrangements may be arranged in the vertical center plane of the casing and respectively in the vertical plane, or a vertical center or center line, of the door.

The first and wireless power transfer and data transceiver arrangements may be arranged in a vertical wall of the casing and respectively in an edge of the door adjacent to the vertical wall.

Moreover, according to the present disclosure there is provided a method of operation of a household appliance having a casing, including an interior cavity, and a door, wherein the household appliance comprises: at least an electrical device which is arranged in/on the door of the appliance, a control unit which is arranged in/on the casing of the appliance and is configured to control the electrical device, a wireless power transmitter and data transceiver arrangement, which is arranged in/on the casing and electrically connected to the control unit via first connection circuitry, and a wireless power receiver and data transceiver arrangement, which is arranged in/on the door and electrically connected to the electrical device via second connection circuitry, the method comprising wirelessly exchanging data and wirelessly supplying electric power for the electrical device by means of the wireless power transmitter and data transceiver arrangement and the wireless power receiver and data transceiver arrangement.

The wireless power transmitter and data transceiver arrangement and the wireless power receiver and data transceiver arrangement respectively may comprise a first and second short-range transceiver module, the method comprising wirelessly exchanging data using bit rates equal to or higher than 480 Mb/s by the first and second short-range transceiver modules.

The first and second connection circuitry may comprise first and second USB electrical connection circuits respectively. The method may comprise performing a tunneling in a USB communication path between the control unit and the electrical device by the first and second short-range transceiver modules.

The appliance may further comprise the first USB electric connectional circuit, arranged in the casing and electrically connecting the wireless power transmitter and data transceiver arrangement to the control unit; and the second USB electrical connection circuit, arranged in the door and electrically connecting the wireless power receiver and data transceiver arrangement to the electrical device, the method may further comprise performing a virtual USB communication channel to exchange data between the first and second USB electrical connection circuits by the first and second short-range transceiver modules.

According to the present disclosure, there is further provided an appliance having a casing and a door, the appliance comprising: a camera arranged in/on the door, a control unit arranged in/on the casing and configured to control the camera, a first short-range wireless RF transceiver and a first coil, arranged in/on the casing and electrically connected to the control unit via a first connection circuit, and a second short-range wireless RF transceiver and a second coil, arranged in/on the door and electrically connected to the camera via a second connection circuit, wherein the first and second short-range wireless RF transceivers are arranged to wirelessly exchange data between the control unit and the camera and the first and second coils are arranged to wirelessly transfer electric power for the camera.

### BRIEF DESCRIPTION OF THE DRAWINGS

Further characteristics and advantages of the present disclosure will be highlighted in greater detail in the following detailed description, provided with reference to the enclosed drawings.

A non-limiting example of the present disclosure will now be described with reference to the accompanying drawings, in which:

FIG. 1 illustrates a schematic perspective view of a household appliance, with parts removed for clarity's sake,

FIG. 2 is a block diagram of an electronic system of the household appliance illustrated in FIG. 1,

FIG. 3 shows another example of a household appliance with the electronic system of FIG. 2, and

FIG. 4 shows yet another example of a household appliance provided with the electronic system of FIG. 2.

### DETAILED DESCRIPTION

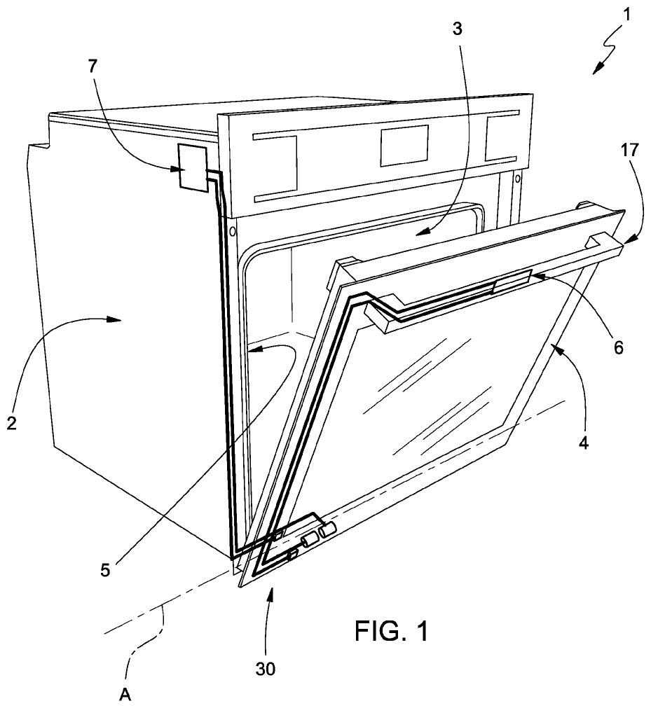

FIG. 1 illustrates a household appliance in the form of a cooking oven 1.

The cooking oven 1 comprises a box frame or casing 2 forming the external appearance of the cooking oven 1, an inner chamber or cavity 3 designed to contain the foodstuff to be cooked and a door 4 movable to open/close the cavity 3. The front side of the box casing 2 comprises an opening corresponding to the opening 5 of the inner cavity 3 through which the foodstuff is introduced in, and extracted from, the inner cavity 3. The opening 5 may be opened and closed by the door 4.

In the example illustrated in FIG. 1, the door 4 is axially supported at its bottom end by the box casing 2, and opens and closes in vertical direction. According to the example illustrated in FIG. 1, the door 4 is axially supported by the box casing 2 in order to rotate around a horizontal axis A between a closed position wherein the door 4 closes the opening 5 and an open position, wherein the user may access the inner cavity 3. According to the example illustrated in FIG. 1 the door 4 may be hinged to the box casing by hinges.

It is however understood that the present disclosure is not limited to a door 4 which may be rotated around the horizontal axis A in order to be opened and closed in a vertical direction, but it may be alternately envisaged a household appliance provided with a door which may be rotated around a vertical axis in order to be opened a closed in horizontal direction.

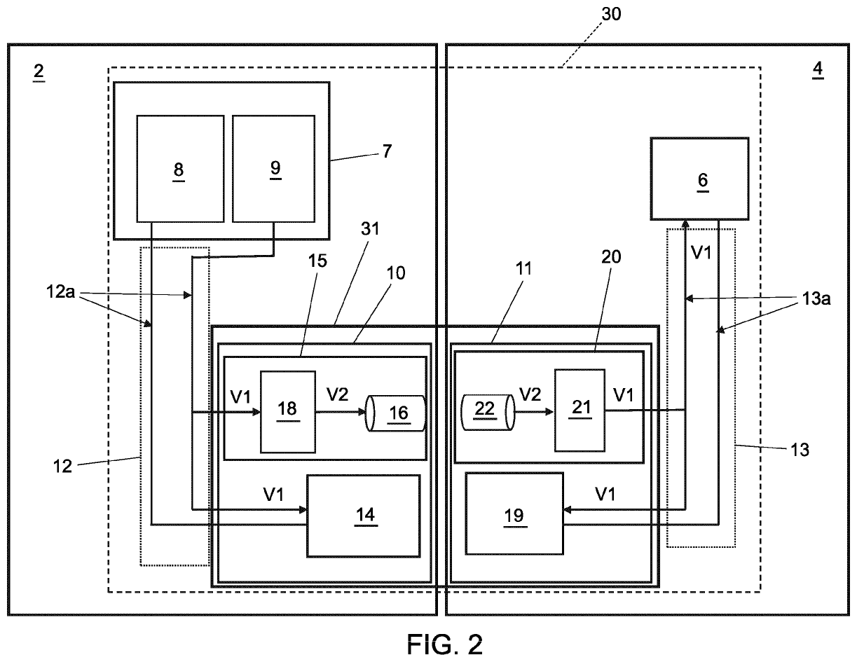

With reference to FIGS. 1 and 2, the cooking oven 1 is further provided with an electronic system 30, which is provided with at least an electrical device 6 arranged in/on the door 4. The electrical device may be a digital camera 6. The camera 6 may be arranged in the door 4 in order to capture pictures of the foodstuff in the inner cavity 3. The camera 6 may be for example arranged in/on a door handle 17 being attached at the outer side of the door 4 or in another convenient position of the door 4.

With reference to FIGS. 1 and 2, the electronic system 30 of the cooking oven 1 is further provided with a control unit 7 which is arranged in/on the box casing 2. The control unit 7 may comprise, for example, a processing unit 8 and a power supply unit 9. The power supply unit 9 may be configured to output a prefixed electrical power (voltage and currents). The processing unit 8 may be configured to provide data/commands to control the camera 6 and to receive the captured pictures, or video data, from the camera 6. The picture and video data may be compressed or uncompressed.

The electronic system 30 of the cooking oven 1 may further be provided with a wireless data and electrical power transmission system 31, which is configured to wirelessly exchange data between the control unit 7 and the electric device 6. The exchanged data may be commands and picture/video data. The wireless data and electrical power transmission system 31 is further configured to wirelessly transmit electrical power from the control unit 7 to the electrical device 6.

The wireless data and electrical power transmission system 31 comprises two wireless power transfer and data transceiver arrangements 10 and 11. The first wireless power transfer and data transceiver unit 10 may be a wireless power transmitter and data transceiver arrangement. The second wireless power transfer and data transceiver unit 11 may be a wireless power receiver and data transceiver arrangement. The wireless power transfer and data transceiver units 10 and 11 are configured to perform a wireless transceiving of data with each other. The power transfer and data transceiver unit 10 is also configured to perform a wireless transfer of electric power to the power transfer and data transceiver unit 11 in order to supply the latter with the electric voltage/current necessary for its operation.

The wireless power transfer and data transceiver unit 10 is arranged in the box casing 2, whereas the wireless power transfer and data transceiver unit 11 is arranged in the door 4. The wireless power transfer and data transceiver unit 10 is electrically connected to the control unit 7 by an electrical connection circuit 12. The electrical connection circuit 12 may comprise a USB electrical wired circuit 12a (Universal Serial Bus) provided with electrical cables or wires, which extend inside the box casing 2 from the control unit 7 to the wireless power transfer and data transceiver unit 10.

The wireless power transfer and data transceiver unit 11 is electrically connected to the digital camera 6 by an electrical connection circuit 13. The electrical connection circuit 13 may comprise a USB electrical wired circuit 13a. The USB electrical wired circuit 13a is provided with cables or wires, which extend inside the door 4 from the wireless power transfer and data transceiver unit 11 to the digital camera 6.

The wireless power transfer and data transceiver modules 10 and 11 are arranged in the casing 2 and in the door 4 respectively, in order to be in adjacent positions to each other. The wireless power transfer and data transceiver modules 10 and 11 may be arranged in the casing 2 and in the door 4 respectively, in order to have a distance from each other less than 3 cm or less than about 3 cm.

The wireless power transfer and data transceiver unit 11 may be arranged in the door 4 in order to be in the adjacent position with the wireless power transfer and data transceiver unit 10, at least when the door 4 is in the closed position.

The wireless power transfer and data transceiver unit 11 may be arranged in the door 4 in order to be in the adjacent position with the wireless power transfer and data transceiver unit 10, when the door 4 is in any position, i.e. closed position, open position and intermediate position.

The electrical connection circuits 12 and 13 may operate according to a USB protocol. For example, wires of the USB electrical wired circuit 12a of the electrical connection circuits 12 may be connected to respective USB pins of USB plug/port (not illustrated) of the control unit 7 based on a USB connections architecture. Wires of the USB electrical wired circuit of the electrical connection circuit 13 may be connected to respective USB pins of a USB plug/port of the digital camera 6 based on a USB connections architecture.

The wireless power transfer and data transceiver unit 10 and the control unit 7 may exchange data/commands with each other by means of the electrical connection circuit 12 by implementing a USB protocol. Similarly, the digital camera 6 and the wireless power transfer and data transceiver units 11 may exchange data/commands with each other by means of the electrical connection circuit 13 by implementing a USB protocol. The USB protocol may be the USB 2.0 or USB 3.0. Alternatively, the protocol may be USB 3.1, USB 3.2 or USB 4.0 protocol or even a later USB protocol. USB 2.0, for example, is defined in the USB 2.0 Specification, released on 27 Apr. 2000 (www.usb.org). The USB electrical connection circuits may operate with a maximum data transfer speed equal to 480 Mb/s. The maximum data transfer speed may alternatively be higher.

Referring to FIG. 2, the wireless power transfer and data transceiver unit 10 comprises a short-range radio frequency (RF) transceiver module 14 and a power transmission module 15.

The short-range RF transceiver module 14 may be electrically connected with the control unit 7 by the USB electrical wired circuit 12a of the electrical connection circuit 12. The USB electrical wired circuit 12a may comprise data-wires for exchanging data between the short-range transceiver module 14 and control unit 7. The processing unit 8 of the control unit 7 may be configured to exchange data/commands with the short-range transceiver module 14 by USB data wires (Data+ and Data−) of the USB electrical wired circuit 12a.

The USB electrical wired circuit 12a may comprises power supply wires, which may receive the supply voltage/current from control unit 7 and provide such supply voltage/current to the short-range transceiver module 14. The power supply unit 9 of the control unit 7 may provide the electrical power supply to the short-range transceiver module 14 by USB electrical power wires (V-bus; ground) of the USB electrical wired circuit of the electrical connection circuit 12.

The short-range transceiver module 14 may be configured to operate in order to wirelessly transmit/receive data from/to the wireless power transfer and data transceiver unit 10 at bit rates equal to or higher than 480 Mb/s. The short-range transceiver module 14 may be configured to operate, to transmit and receive data, over a wide bandwidth that allows such bit rates. For example it may transmit and receive data over a bandwidth of more than 500 MHz. It may receive a data signal from the USB connection circuit operating according to a particular USB protocol, convert that signal into a wireless signal and transmit the wireless signal at full data speeds of that USB protocol or data speeds that match the data speeds in the USB connection circuit. Alternatively, it may receive a wireless signal at full speeds of the USB protocol and convert the wireless signal into a signal to be transferred in the USB connection circuit. As an example, the USB protocol could be the USB 2.0 or USB 3.0 protocol. However, it could alternatively be a later protocol, such as the USB 3.1, USB 3.2 or USB 4.0 protocol or even a later USB protocol.

The short-range transceiver module 14 may comprise a radio frequency (RF) millimeter-wave transceiver. The short-range transceiver module 14 may comprise a V-Band transceiver for short range contactless connectivity. The V-Band transceiver may be configured to operate over a band of frequencies in the microwave portion of the electromagnetic spectrum ranging from about 40 to 75 GHz. For example, the V-Band transceiver may comprise a “60 GHz RF transceiver” operating at a frequency of 60 GHz. For example, the Applicant has found it advantageous to use a short-range transceiver module 14 comprising the electronic device named “ST60A2G0” manufactured by STMicroelectronics. However, other V-Band and/or Ultra Wideband (UWB) RF transceivers may be used.

Referring to FIG. 2, the power transmission module 15 comprises an electric coil 16 and a power driver or power circuit 18. The power circuit 18 is configured to control the coil 16 to wirelessly transmit electric power to the power receiver module 20. The power circuit 18 may be configured to receive an electric power supply from the control unit 7.

According to an example, the power circuit 18 receives the electric power (voltage/current) supplied from the control unit 7 by means of the USB electrical wired circuit 12a of the electrical connection circuit 12. For example, the power circuit 18 may be configured to receive a USB voltage/current from the power supply unit 8 by means of the USB electrical wired circuit 12a of the electrical connection circuit 12, i.e. a direct voltage V1 (e.g. USB voltage of 5V). In this case, the power circuit 18 may be configured to convert the direct voltage V1 to an alternating voltage V2, and provide the alternating voltage V2 to the coil 16. As a specific non-limiting example, the power circuit may provide an AC coupled wireless power transfer system of 1W to 2W using a frequency of for example 90 kHz. However, this is just an example and other implementations are possible.

Referring to FIG. 2, the wireless power transfer and data transceiver unit 11 comprises a short-range RF transceiver module 19 and a power receiving module 20.

The power receiving module 20 may comprise an electric coil 22 and a power controller 21. The coil 22 is configured to wirelessly receive the electric power from the coil 16, and provides as output the alternating voltage V2 to the power controller 21, which in turn provides as output the direct voltage V1. The power controller 21 may be configured to convert the alternating voltage V2 to the direct voltage V1. In some examples, the power controller 21 provides the electric power supply, i.e. the voltage V1, to the short-range transceiver module 19. Moreover, the power controller 21 provides the electric power supply V1 to the camera 6. The power controller 21 provides the electric power supply. i.e. the voltage V1 to the camera 6 by means of the USB electrical wired circuit 13a of the electrical connection circuit 13. The power controller 21 provides the electric power supply, i.e. the voltage V1, to the short-range transceiver module 19 by means of the USB electrical wired circuit 13a of the electrical connection circuit 13.

The short-range transceiver module 19 may be configured to operate in order to wirelessly transmit/receive data to/from the short-range transceiver module 14 at a bit rate equal to or higher than 480 Mb/s. Like the short-range transceiver module 14 in the casing, the short-range transceiver module 19 may be configured to operate, to transmit and receive data, over a wide bandwidth that allows such bit rates. For example it may operate over a bandwidth of more than 500 MHz. It may receive a data signal from the USB connection circuit operating according to a particular USB protocol, convert that signal into a wireless signal and transmit the wireless signal at full data speeds of that USB protocol or data speeds that match the data speeds in the USB connection circuit. Alternatively, it may receive a wireless signal at full speeds of the relevant USB protocol and convert the wireless signal into a signal to be transferred in the USB connection circuit. As an example, the USB protocol could be the USB 2.0 or USB 3.0 protocol. However, it could alternatively be a later protocol, such as the USB 3.1, USB 3.2 or USB 4.0 protocol or even a later USB protocol.

The short-range transceiver module 19 may comprise a RF millimeter-wave transceiver. The short-range transceiver module 19 may comprise a V-Band transceiver for short range contactless connectivity. The V-Band transceiver may be configured to operate for a band of frequencies in the microwave portion of the electromagnetic spectrum ranging from about 40 to 75 GHz. For example, V-Band transceiver may comprise a 60 GHz RF transceiver operating for a frequency of 60 GHz. The 60 GHz RF transceiver may comprise, for example, the electronic device named “ST60A2G0” manufactured by STMicroelectronics. However, this is just one example and it will be appreciated that other implementations are possible. For example, other V-Band and/or Ultra Wideband (UWB) RF transceivers may be used.

It will be appreciated that the short-range transceiver modules 14, 19 may further be configured to also transmit data at lower bit rates than described in some of the examples herein when/if the bit rates of the data in the USB electrical connection circuits are lower, at certain times, in those examples. The short-range transceiver modules may be able to operate at the high speeds to keep up with the data transfer rates in the USB electrical connection circuits.

The Applicant has found that the architecture of the wireless data and electrical power transmission system 31 above disclosed has the technical effect of increasing the amount of data, i.e. the pictures, communicated from the camera 6 to the control unit 7 without causing an increase of the complexity of the software and hardware of the wireless system. In fact, the architecture of the system 31 makes it compatible to interface with USB communication channels present in the appliance and therefore does not require substantial changes in the configuration of the communication protocol itself.

The wireless data and electrical power transmission system 31 allows, on the one hand, to interface with a digital camera 6 having a USB communication architecture (SW/HW), and on the other hand, it increases the communication performance in terms of data rate for data exchange between the camera and the control unit. Since the short-range wireless transceiver modules 14 and 19 can be connectable with USB communication lines they are able to perform a wireless tunneling channel. Tunnelling may be understood to mean that the wireless transceiver, once powered, can establish the RF connection automatically, transferring the data in both directions and establishing a virtual USB connection from the electronic board of the appliance to the electronic peripheral. The peripheral effectively acts as if it was plugged to the USB port of the electronics of the appliance. The tunneling causes high speed data communication between the USB branch lines USB connecting the control unit 7 to the camera 6. It follows that the short-range transceiver modules 14 and 19 automatically performs a “virtual high speed data channel” connecting the USB branch lines of the control unit 7 and the camera 6. Indeed, the use of short-range transceiver modules as described in some examples avoids the need of identification protocols and provides a very limited spreading of radiation.

Furthermore, the wireless transmission of electrical power to the camera determines the elimination of the electric batteries in the door, with all the advantages that this entails for the user in terms of ease of use of the system. Indeed, since the camera 6 is electrically supplied by the power transfer and data transceiver module 11, the camera 6 does not need any electric battery system.

Referring to FIG. 1, the coils 16 and 22 are arranged in box casing 2 and in the door 4 respectively, in order to be coaxial to each other. According to an example, coils 16 and 22 may be arranged/integrated in a hinge (not illustrated) which connects the door to the box casing 2. The Applicant has found that the coaxial arrangement of the coils 16 and 22 allows to maintain the camera 6 and the wireless power transfer and data transceiver unit 11 supplied by electrical power, even when the door 4 is open.

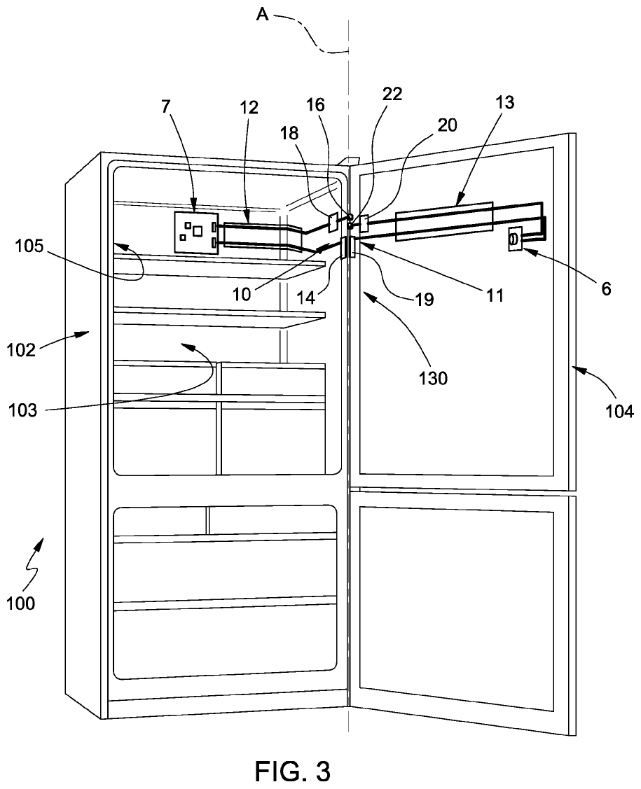

The example illustrated in FIG. 3 relates to household appliance corresponding to a refrigerator appliance 100. The refrigerator appliance 100 is adapted for preserving perishable foodstuff. Refrigerator appliance 100 may comprise a substantially parallelepiped-shaped, self-supporting cabinet 102, which has a thermal-insulating structure and is internally provided with at least one, substantially parallelepiped-shaped, thermal-insulated storage inner cavity 103, which is adapted to accommodate food-stuff and communicates with the outside via a large, roughly rectangular-shaped, access opening 105, which is located on a main face/wall of the cabinet 102.

The refrigerator appliance 100 further comprises at least one door 104, that has a thermal-insulating structure and is flag hinged to the cabinet 102, so as to be manually rotatable to and from a closing position in which the door abuts on the main face/wall of the cabinet 102 to substantially airtight close/seal the access opening of the storage inner cavity 104. In the example shown, in particular, the self-supporting cabinet 102 may be structured for stably resting on the floor/ground.

Referring to FIG. 3, the refrigerator appliance 100 further comprises an electronic system 130, which is similar to the electronic system 30 of the cooking oven 1, and whose component parts will be identified, where possible, with the same reference numbers that identify corresponding parts of the electronic control system 30.

The electronic system 130 differs from the electronic control system 30 due to the fact that it has the control unit 7 arranged in the self-supporting cabinet 102 of the refrigerator appliance 100, the wireless power transfer and data transceiver unit 10 arranged in in the self-supporting cabinet 102 of the refrigerator appliance 100, the wireless power transfer and data transceiver unit 11 arranged in the door 104 and the electric device 6 arranged in the door 104.

Moreover, the electronic system 130 differs from the electronic control system 30 due to the fact that it has the electrical connection circuits 12 and 13 arranged in the self-supporting cabinet 102 and in the door 104, respectively.

The wireless power transfer and data transceiver unit 10 may be arranged in/on the edge of a vertical wall surrounding the refrigerator opening 105 so as to be adjacent to the wireless power transfer and data transceiver unit 11 arranged in the door 104. The wireless power transfer and data transceiver unit 10 and the wireless power transfer and data transceiver unit 11 may be arranged/integrated in a hinge connecting the edge of the wall of the self-supporting cabinet 102 with the edge of the door 104.

The Applicant has found that the application of this architecture in a refrigerator appliance allows for significantly reduction of the length of the USB communication branches/wires in the self-supporting cabinet 102 and in the door 104.

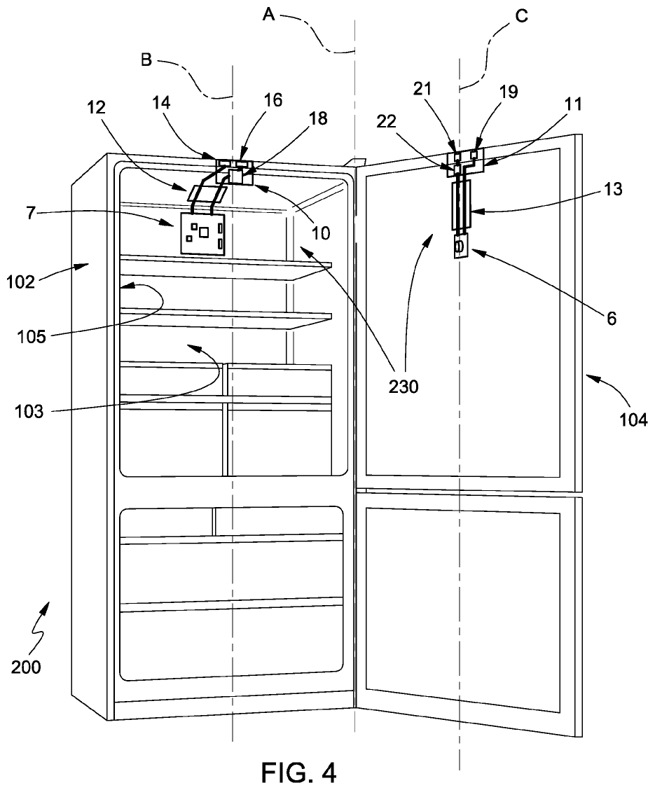

The example illustrated in FIG. 4 schematically illustrates a household appliance corresponding to a refrigerator appliance 200 comprising an electronic system 230, which is similar to the electronic system 130 of the refrigerator appliance 100 (and the cooking oven 1) and whose component parts will be identified, where possible, with the same reference numbers that identify corresponding parts of the electronic system 130.

The electronic system 230 differs from the electronic system 130 of refrigerator appliance 100 due to the fact that the wireless power transfer and data transceiver unit 10 is arranged in the self-supporting cabinet 102 in order to be in the vertical center plane B of the self-supporting cabinet 102 itself, and to the fact that the wireless power transfer and data transceiver unit 11 is arranged in/on the door 104 in order to be in the vertical center plane C of the door 104 itself. The wireless power transfer and data transceiver unit 10 associated with the cabinet may be located in the center or in a central region with respect to the two longer side walls of the cabinet and the wireless power transfer and data transceiver unit 11 associated with the door may be located in the center or in a central region of the door at a similar height, or distance from the shorter side of the appliance arranged to rest on the floor/ground, as the wireless power transfer and data transceiver unit 10 associated with the cabinet. They may be located on the centerline, or near the centerline, of the door and on the case of the refrigerator respectively.

When the door 104 is its closed position, wireless power transfer and data transceiver units 10 and 11 face each other and are adjacent to each other, and are able to perform the mutual wireless communication of data and electrical power.

The Applicant has found that the aforementioned positioning of the wireless power transfer and data transceiver units 10 and 11 in the vertical center planes B and C makes the wireless system configured to be suitable in order to operate for both the right-hand opening door configuration and the left-hand opening door configuration. It follows that in refrigerator 200, it is possible to change the opening direction of the door right to left or vice versa, without any rewiring activity.

It is understood that the present disclosure is not limited to a household appliance provided with an electrical device corresponding to a camera but it can alternatively or additionally provide electronic devices other than the camera such as, for example, displays, electronic sensors, etc. For example, according to an example (not illustrated), the household appliance is provided with a plurality of electrical devices which are arranged in the door, and are connected to the wireless power transfer and data transceiver unit 11 by respective electrical connections circuits 13. In this example, for example the electrical connections circuits 13 may be connected to the wireless power transfer and data transceiver unit 11 by an USB hub device (not illustrated).

The household appliance described above is advantageous in that it allows to increase the bit rate of the data communication without increasing the hardware and software complexity of the communication system, and eliminates the need to use batteries to power the electrical device.

Clearly, changes may be made to the household appliance without, however, departing from the scope of the present disclosure.

1. A household appliance comprising:
a casing comprising an interior cavity and a door,
an electrical device arranged in/on the door,
a control unit arranged in/on the casing, wherein the control unit is configured to control the electrical device,
a first wireless power transfer and data transceiver arrangement arranged in/on said casing and configured to be electrically connected to the control unit via first USB electrical connection circuitry, and
a second wireless power transfer and data transceiver arrangement arranged in/on the door and configured to be electrically connected to the electrical device via second USB electrical connection circuitry,
wherein the first wireless power transfer and data transceiver arrangement and the second wireless power transfer and data transceiver arrangement are arranged to wirelessly exchange data and wirelessly transfer electric power for the electrical device.

2. The household appliance according to claim 1, wherein:
the first USB electrical connection circuitry is arranged in the casing and electrically connects the first wireless power transfer and data transceiver arrangement to said control unit; and
the second USB electrical connection circuitry is arranged in said door and electrically connects the second wireless power transfer and data transceiver arrangement to said electrical device.

3. The household appliance according to claim 1, wherein the first wireless power transfer and data transceiver arrangement and the second wireless power transfer and data transceiver arrangement respectively comprise a first short-range transceiver module and a second short-range transceiver module, and wherein the first short-range transceiver module and the second short-range transceiver module are configured to wirelessly receive and transmit data using bit rates equal to or higher than about 480 Mb/s.

4. The household appliance according to claim 2, wherein the first wireless power transfer and data transceiver arrangement comprises:
a first short-range transceiver module electrically connected to the control unit by the first USB electrical connection circuitry to exchange data based on a USB protocol, and wherein the first short-range transceiver module is configured to transmit/receive data at bit rates equal to or higher than about 480 Mb/s, and
a first coil configured to wirelessly transfer electric power.

5. The household appliance according to claim 4, wherein the second wireless power transfer and data transceiver arrangement comprises:
a second short-range transceiver module electrically connected to the electrical device by the second USB electrical connection circuitry to exchange data based on a USB protocol, and wherein the second short-range transceiver module is configured to transmit/receive data at bit rates equal to or higher than about 480 Mb/s to/from the first short-range transceiver module, and
a second coil configured to wirelessly receive the electric power from the first coil and supply the received electric power to the second short-range transceiver module and to the electrical device by the second USB electrical connection circuitry.

6. The household appliance according to claim 5, wherein the first short-range transceiver module and the second short-range transceiver module are configured to perform a tunneling in a USB communication path between the control unit and the electrical device.

7. The household appliance according to claim 3, wherein the first short-range transceiver module and the second short-range transceiver module are configured to perform a virtual USB communication channel to exchange data between the first USB electrical connection circuitry and the second USB electrical connection circuitry.

8. The household appliance according to claim 3, wherein each of the first short-range transceiver module and the second short-range transceiver module comprises an RF millimeter-wave transceiver.

9. The household appliance according to claim 3, wherein each of the first short-range transceiver module and the second short-range transceiver module comprises a V-Band transceiver.

10. The household appliance according to claim 3, wherein the first short-range transceiver module and the second short-range transceiver module are arranged in the casing and the door respectively, at a distance less than 3 cm from each other.

11. The household appliance according to claim 5, wherein the first coil and the second coil are coaxial to each other.

12. The household appliance according to claim 1, wherein the electrical device comprises a digital camera, a display lighting device, a sensor, or a USB interface hub device.

13. The household appliance according to claim 1, wherein the household appliance is a cooking oven.

14. The household appliance according to claim 1, wherein the household appliance is a refrigerator appliance.

15. The household appliance according to claim 1, wherein said first wireless power transfer and data transceiver arrangement and said second wireless power transfer and data transceiver arrangement are arranged in a hinge connecting the door to the casing.

16. The household appliance according to claim 1, wherein the first wireless power transfer and data transceiver arrangement is arranged in a vertical center plane of the casing and the second wireless power transfer and data transceiver arrangement is arranged in a vertical center plane of the door.

17. The household appliance according to claim 1, wherein the first wireless power transfer and data transceiver arrangement is arranged in a vertical wall of the casing and the second wireless power transfer and data transceiver arrangement is arranged in an edge of the door adjacent to the vertical wall.

18. A method of operating a household appliance, wherein the household appliance comprises:
a casing comprising an interior cavity and a door,
an electrical device arranged in/on the door,
a control unit arranged in/on the casing, wherein the control unit is configured to control the electrical device,
a wireless power transmitter and data transceiver arrangement arranged in/on the casing and electrically connected to the control unit via first connection circuitry, and
a wireless power receiver and data transceiver arrangement arranged in/on the door and electrically connected to the electrical device via second connection circuitry, and
wherein the method comprises wirelessly exchanging data and wirelessly supplying electric power for the electrical device using the wireless power transmitter and data transceiver arrangement and the wireless power receiver and data transceiver arrangement.

19. The method according to claim 18, wherein the wireless power transmitter and data transceiver arrangement and the wireless power receiver and data transceiver arrangement respectively comprise a first short-range transceiver module and a second short-range transceiver module, and wherein the method comprises wirelessly exchanging data using bit rates equal to or higher than about 480 Mb/s by the first short-range transceiver module and the second short-range transceiver module.

20. The method according to claim 19, wherein each of the first connection circuitry and the second connection circuitry comprises USB connection circuitry and the method comprises performing a tunneling in a USB communication path between the control unit and the electrical device using the first short-range transceiver module and the second short-range transceiver module.

21. The method according to claim 19, wherein the appliance further comprises:
a first USB electric connection circuit arranged in the casing and electrically connecting the wireless power transmitter and data transceiver arrangement to the control unit; and
a second USB electric connection circuit arranged in the door and electrically connecting the wireless power receiver and data transceiver arrangement to the electrical device; and
wherein the method comprises performing a virtual USB communication channel to exchange data between the first USB electric connection circuit and the second USB electric connection circuit using the first short-range transceiver module and the second short-range transceiver module.

22. An appliance comprising:
a casing;
a door;
a camera arranged in/on the door,
a control unit arranged in/on the casing and configured to control the camera,
a first short-range wireless RF transceiver and a first coil, arranged in/on the casing and electrically connected to the control unit via a first connection circuit, and
a second short-range wireless RF transceiver and a second coil, arranged in/on the door and electrically connected to the camera via a second connection circuit, wherein the first short-range wireless RF transceiver and the second short-range wireless RF transceiver are arranged to wirelessly exchange data between the control unit and the camera, and wherein the first and second coils are arranged to wirelessly transfer electric power for the camera.
